(19) United States
(12) Patent Application Publication
(10) Pub. No.: US 2009/0252235 A1
(43) Pub. Date: Oct. 8, 2009

(54) METHOD OF MODULATION MODE DETECTION FOR COMMUNICATION SYSTEM

(76) Inventors: Jeng-Shiann Jiang, Tainan County (TW); Chin-Jung Tsai, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/098,452

(22) Filed: Apr. 7, 2008

(51) Int. Cl. H04B 3/00

(52) U.S. Cl. 375/257

(57) ABSTRACT

A method of modulation mode detection for a communication system including at least a channel transmitting signals utilizing a target modulation mode is provided. The method includes: (a) selecting a default modulation mode for the channel; (b) estimating a timing frequency offset (TFO) of the channel of the communication system for obtaining at least a TFO value and storing the TFO value; (c) comparing the TFO value with a first predetermined value to generate a comparison result; and (d) determining whether the default modulation mode is substantially identical to the target modulation mode according to the comparison result.

### BACKGROUND OF THE INVENTION

1. Field of the Invention

The present invention relates to a method of modulation mode detection for a communication system, and more particularly, to a method of modulation mode detection and fast channel auto-scan for a communication system including a plurality of channels and supporting different modulation modes and symbol rates.

2. Description of the Prior Art

A conventional method of modulation mode detection for a communication system having different modulation modes (such as the cable system ITU-T J.83B) utilizes constellation statistic characteristics after a blind equalization to select a correct modulation mode.

However, the conventional method has to wait after an equalizer converging to determine the correct modulation mode. Thus, it takes a lot of time. Furthermore, using the conventional method to perform a channel auto-scan process also takes a lot of time.

### SUMMARY OF THE INVENTION

It is therefore one of the objectives of the present invention to provide a method of modulation mode detection for a communication system including a plurality of channels and supporting different modulation modes and symbol rates to solve the above problem.

According to an embodiment of the present invention, a method of modulation mode detection for a communication system including at least a channel transmitting signals utilizing a target modulation mode is disclosed. The method includes: (a) selecting a default modulation mode for the channel; (b) estimating a timing frequency offset (TFO) of the channel in the default modulation mode for obtaining at least a TFO value and storing the TFO value; (c) comparing the TFO value with a first predetermined value to generate a comparison result; and (d) determining whether the default modulation mode is substantially identical to the target modulation mode according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a PLL in the communication system.

FIG. 2 is a flowchart showing an embodiment of a method of modulation mode detection for a communication system including a plurality of channels respectively transmitting signals utilizing a target modulation mode according to the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not differ in function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

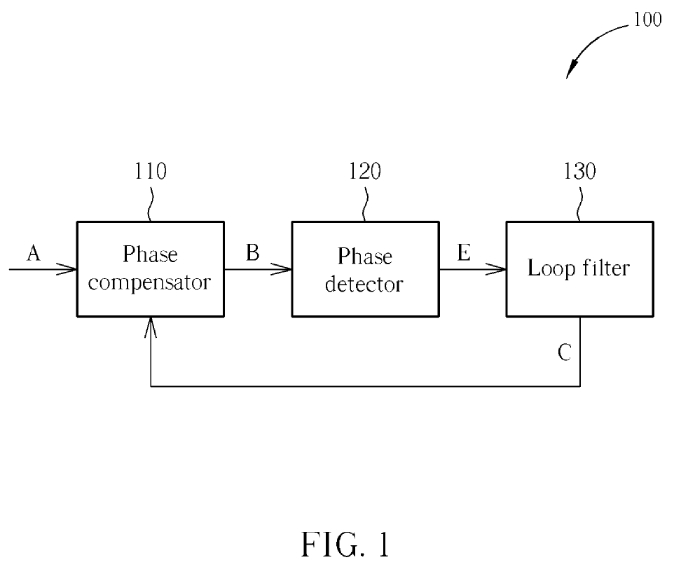

A method of modulation mode detection for a communication system including a plurality of channels and supporting different modulation modes and symbol rates is provided. For example, the cable system ITU-T J.83B has two modulation modes: 64QAM and 256QAM. The symbol rates of 64QAM and 256QAM modulation modes are 5.057 Msps (mega symbols per second) and 5.361 Msps, respectively. When a TX and a RX of a channel of the communication system (such as the cable system ITU-T J.83B) has a same modulation mode, a timing frequency offset (TFO) of the channel of the communication system will be smaller than 200 ppm. When the TX and the RX of the channel of the communication system has different modulation modes, the TFO of the channel of the communication system will be greater than 10000 ppm. Please refer to FIG. 1. FIG. 1 shows a simplified block diagram of a phase lock loop (PLL) 100 in the communication system. The PLL 100 comprises a phase compensator 110, a phase detector 120, and a loop filter 130. The phase detector 120 is utilized for estimating a residual phase difference E of a signal B that is a signal A passing through the phase compensator 110. The loop filter 130 is utilized for stabilizing the residual phase difference E to generate a phase difference C. The phase compensator 110 is utilized for compensating the phase difference C. Estimation of the TFO of the channel of the communication system can be performed by the PLL 100 in front stage of an equalizer. Thus, the method of the present invention performs the modulation mode detection and fast channel auto-scan for the communication system without waiting for the equalizer converging.

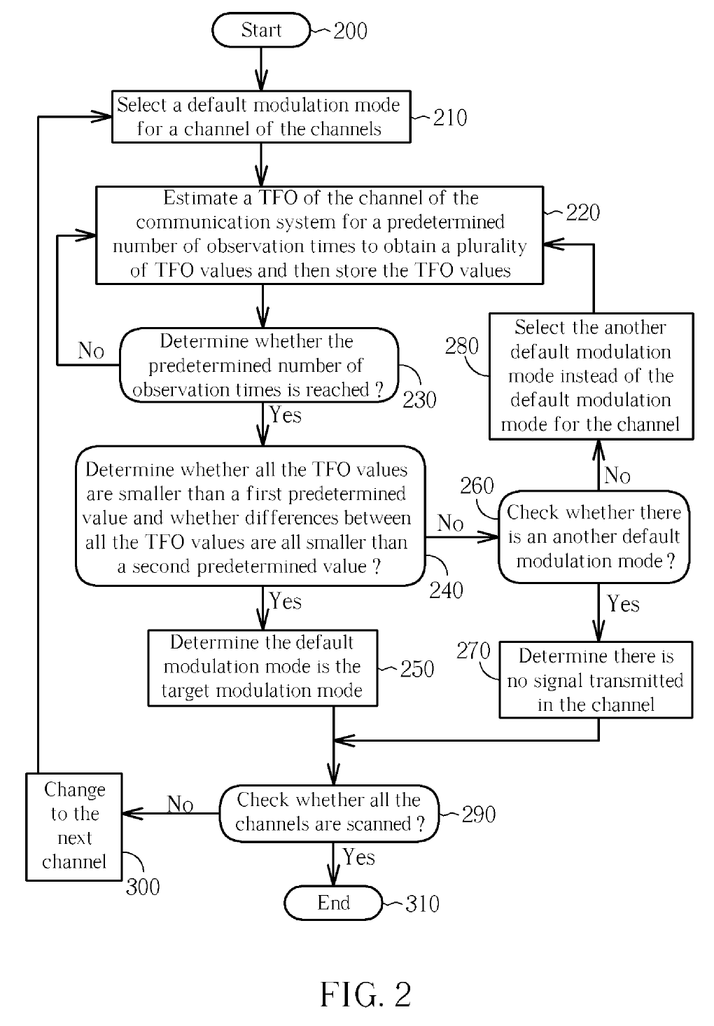

Please refer to FIG. 2. FIG. 2 is a flowchart showing an embodiment of a method of modulation mode detection for a communication system including a plurality of channels respectively transmitting signals utilizing a target modulation mode according to the present invention. Provided that substantially the same result is achieved, the steps of the process flowchart need not be in the exact order shown and need not be contiguous; that is, other steps can be intermediate. The embodiment of the method according to the present invention includes the following steps:

Step 200: Start.

Step 210: Select a default modulation mode for a channel of the channels.

Step 220: Estimate a TFO of the channel of the communication system for a predetermined number of observation times to obtain a plurality of TFO values and then store the TFO values.

Step 230: Determine whether the predetermined number of observation times is reached. If yes, go to Step 240; otherwise, go to Step 220.

Step 240: Determine whether all the TFO values are smaller than a first predetermined value and whether differences between all the TFO values are all smaller than a second predetermined value; when all the TFO values are smaller than the first predetermined value and the differences between all the TFO values are smaller than the second predetermined value, go to Step 250; otherwise, go to Step 260.

Step 250: Determine the default modulation mode is the target modulation mode.

Step 260: Check whether there is an another default modulation mode; if yes, go to Step 270; otherwise, go to Step 280.

Step 270: Determine there is no signal transmitted in the channel.

Step 280: Select the another default modulation mode instead of the default modulation mode for the channel.

Step 290: Check whether all the channels are scanned; if yes, go to Step 310; otherwise, go to Step 300.

Step 300: Change to the next channel.

Step 310: End

Please note that the above embodiment is only for illustrative purposes and is not meant to be a limitation of the present invention.

In addition, when the method in the present invention is utilized in the cable system ITU-T J.83B, the first predetermined value can be 200 ppm, and the second predetermined value can be 2 ppm. However, this is only for illustrative purposes and is not meant to be a limitation of the present invention.

Briefly summarized, the method disclosed by the present invention can save a lot of time in performing the modulation mode detection and fast channel auto-scan for the communication system including a plurality of channels and supporting different modulation modes and symbol rates.

Those skilled in the art will readily observe that numerous modifications and alterations of the device and method may be made while retaining the teachings of the invention.

What is claimed is:

1. A method of modulation mode detection for a communication system comprising at least a channel transmitting signals utilizing a target modulation mode, the method comprising:
(a) selecting a default modulation mode for the channel;
(b) estimating a timing frequency offset (TFO) of the channel in the default modulation mode for obtaining at least a TFO value and storing the TFO value;
(c) comparing the TFO value with a first predetermined value to generate a comparison result; and
(d) determining whether the default modulation mode is substantially identical to the target modulation mode according to the comparison result.

2. The method of claim 1, wherein step (b) comprises estimating the TFO of the channel of the communication system for a predetermined number of observation times to obtain a plurality of TFO values and storing the TFO values; and step (c) comprises comparing the TFO values with the first predetermined value to generate the comparison result.

3. The method of claim 2, wherein step (d) comprises:
when a number of TFO values each being smaller than the first predetermined value is greater than or equal to a predetermined number, determining that the default modulation mode is substantially identical to the target modulation mode;
otherwise, checking whether there is an another default modulation mode; if yes, selecting the another default modulation mode instead of the default modulation mode for the channel and then repeating steps (b) to (d); otherwise, determining there is no signal transmitted in the channel.

4. The method of claim 3, wherein the predetermined number is equal to a total number of the TFO values obtained in step (b).

5. The method of claim 2, wherein step (c) further comprises:
when a number of TFO values each being smaller than the first predetermined value is greater than or equal to a first predetermined number, comparing differences between all the TFO values with a second predetermined value to generate the comparison result.

6. The method of claim 5, wherein the first predetermined number is equal to a total number of the TFO values obtained in step (b).

7. The method of claim 5, wherein step (d) comprises:
when a number of differences each being smaller than the second predetermined value is greater than or equal to a second predetermined number, determining that the default modulation mode is substantially identical to the target modulation mode; otherwise, checking whether there is an another default modulation mode; if yes, selecting the another default modulation mode instead of the default modulation mode for the channel and then repeating steps (b) to (d); otherwise, determining there is no signal transmitted in the channel.

8. The method of claim 7, wherein the second predetermined number is equal to a total number of the differences obtained in step (c).

9. The method of claim 5, wherein the communication system is a cable system ITU-T J.83B.

10. The method of claim 9, wherein the first predetermined value is 200 ppm, and the second predetermined value is 2 ppm.

11. The method of claim 1, wherein the communication system comprises a plurality of channels, and steps (a) to (d) are performed for scanning each of the channels.

12. The method of claim 1, wherein the communication system is a cable system ITU-T J.83B.

13. The method of claim 12, wherein the first predetermined value is 200 ppm.
